(19) United States
(12) Patent Application Publication
(10) Pub. No.: US 2023/0410140 A1
(43) Pub. Date: Dec. 21, 2023

(54) SYSTEM AND METHOD FOR SENSOR-BASED SOCIAL DISTANCING

(71) Applicant: Wells Fargo Bank, N.A., San Francisco, CA (US)

(72) Inventor: Brian J. Jacobsen, Elm Grove, WI (US)

(21) Appl. No.: 17/247,103

(22) Filed: Nov. 30, 2020

(51) Int. Cl. G06Q 30/02; H04W 4/029; H04W 4/021; G06F 16/23; G06F 16/9535; G06F 16/9537; G01V 9/00

(52) U.S. Cl. CPC G06Q 30/0234; H04W 4/029; H04W 4/021; G01G 19/44; G06F 16/9535; G06F 16/9537; G01V 9/00; G06F 16/2379

(57) ABSTRACT

Various examples are directed to computer-implemented systems and methods for sensor-based social distancing. A method includes communicating with a first set of one or more sensors to determine whether a first group of a plurality of users is located within a first portion of a premises, and communicating with a second set of one or more sensors to determine whether a second group of the plurality of users is located within a second portion of the premises. A datastore is queried to determine whether the premises is affiliated with an entity that offers rewards for maintaining social distancing. User profiles of the users of the first group and user profiles of the users of the second group are updated to indicate a reward is available when the first group is located within the first portion and the second group is located within the second portion for a predetermined duration.

### CROSS REFERENCE TO RELATED APPLICATIONS

This application is related to co-pending, commonly assigned U.S. patent application Ser. No. ______, entitled “SYSTEM: AND METHOD FOR SENSOR-BASED MASK DETECTION” (Attorney Docket No. 4423.376US1), and related to co-pending, commonly assigned U.S. patent application Ser. No. ______, entitled “ENFORCING SOCIAL DISTANCING USING TECHNOLOGY” (Attorney Docket No. 4423.377US1), both filed on even date herewith, which are hereby incorporated by reference herein in their entirety.

### BACKGROUND

In view of the proliferation of contagious airborne viruses, maintaining distance from other people in public, commonly referred to as “social distancing,” has significant importance. Some experts have opined that social distancing is one of the most effective tools in limiting the spread of Covid-19 and other communicable airborne viruses. Some people find it difficult to remember to socially distance from others when in a retail setting or other public enclosed space.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 illustrates an example embodiment of a computer system for use in the present subject matter;

FIG. 2 illustrates an exemplary infrastructure for use in the present subject matter;

FIG. 3 illustrates an example embodiment of a method for sensor-based social distancing, according to various embodiments;

FIG. 4 illustrates example embodiments of sensors for use at a premises, according to various embodiments; and

FIG. 5 is a block diagram of a machine in the example form of a computer system within which a set of instructions may be executed, for causing the machine to perform any one or more of the methodologies discussed herein.

### DETAILED DESCRIPTION

A person may not be aware of other persons in their vicinity when in public spaces. Therefore, there is a technical problem to ensure that people maintain a set minimum distance spacing between them for proper social distancing. The present subject matter provides systems and methods for sensor-based social distancing. Some retail stores have markings or indications on the floor to show designated areas for a single person (or small group or cohort) to stand while waiting in line. For example, a retail store may have circles or squares on the floor (respective areas) in the checkout area, such that if all people are within their respective areas, the group is complying with social distancing.

In various embodiments, the present subject matter provides incentives for a group of people to avoid close proximity to another group of people. In some embodiments, the present subject matter provides incentive to maintain social distancing in a group setting, such as in a check-out aisle at a retail store. The present subject matter can detect that groups of users in a line are complying using communication with sensors and provide rewards if all are complying, such that the group effort is rewarded, in various embodiments.

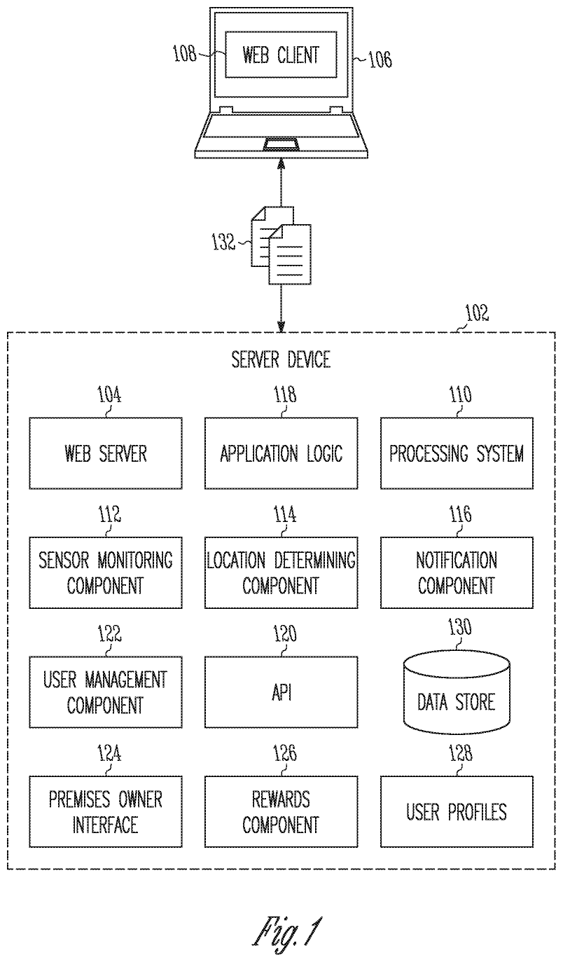

FIG. 1 illustrates an example embodiment of a computer system for use in the present subject matter. FIG. 1 comprises a server device 102, web server 104, client device 106, web client 108, processing system 110, sensor monitoring component 112, location determining component 114, notification component 116, application logic 118, application programming interface (API) 120, user management component 122, premises owner interface 124, rewards component 126, user profiles 128, data store 130, and data 132.

Client device 106 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device. Client device 106 may be associated with one or more entities that interact with server device 102. An entity may be an individual, group of individuals, or company in various examples.

Client device 106 and Server device 102 may communicate via a network (not shown), The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

Client device 106 and server device 102 may communicate data 132 over the network. Data 132 may be, but is not limited to, search requests, search results, market offers (as discussed in more detail below), user information, validation results, and decision results.

In some examples, the communication may occur using an application programming interface (API) such as API 120. An API provides a method for computing processes to exchange data. A web-based API (e.g., API 120) may permit communications between two or more computing devices such as a client and a server.

Server device 102 is illustrated as set of separate elements (e.g., component, logic, etc.). However, the functionality of individual elements may be performed by a single element. An element may represent computer program code that is executable by processing system 110. The program code may be stored on a storage device (e.g., data store 130) and loaded into a memory of the processing system 110 for execution. Portions of the program code may be executed in a parallel across multiple processing units (e.g., a core of a general-purpose computer processor, a graphical processing unit, an application specific integrated circuit, etc.) of processing system 110. Execution of the code may be performed on a single device or distributed across multiple devices. In some example, the program code may be executed on a cloud platform (e.g., MICROSOFT AZURE® and AMAZON EC2®) using shared computing infrastructure.

Server device 102 may include web server 104 to enable data exchanges with client device 106 via web client 108. Although generally discussed in the context of delivering webpages via the Hypertext Transfer Protocol (HTTP), other network protocols may be utilized by web server 104 (e.g., File Transfer Protocol, Telnet, Secure Shell, etc.). A user may enter in a uniform resource identifier (URI) into web client 108 (e.g., the INTERNET EXPLORER® web browser by Microsoft Corporation or SAFARI® web browser by Apple Inc.) that corresponds to the logical location (e.g., an Internet Protocol address) of web server 104. In response, web server 104 may transmit a web page that is rendered on a display device of a client device (e.g., a mobile phone, desktop computer, etc.).

Additionally, web server 104 may enable a user to interact with one or more web applications provided in a transmitted web page. A web application may provide user interface (UI) components that are rendered on a display device of client device 106. The user may interact (e.g., select, move, enter text into) with the UI components, and based on the interaction, the web application may update one or more portions of the web page. A web application may be executed in whole, or in part, locally on client device 106. The web application may populate the UI components with data from external sources or internal sources (e.g., data store 130) in various examples.

For example, server device 102 may provide a web application (e.g., user management component 122) to a user to provide an interface for the user to interact with the application. Data store 130 may store user information and/or rewards information, including unique identifiers to identify users and respective portions with a premises.

That is, in the various examples described herein, an application may provide by the server 102 that permits a user (e.g., via the client device 106) to receive, view, access, and redeem rewards. As further described herein, rewards may be offered for activity related to social distancing. Further, the application provided by the server 102 may provide one or more alerts. For instance, alerts may also be related to complying with social distancing. In certain examples, the application may also facilitate communication with one more sensors. For instance, this may be facilitated using integrated technology of the client device 106, such as wireless communication technology of a user device (e.g., a smartphone).

The web application may be executed according to application logic 118. Application logic 118 may use the various elements of server device 102 to implement the web application. For example, application logic 118 may issue API calls to retrieve or store data from data store 130 and transmit it for display on client device 106. Similarly, data entered by a user into a tit component may be transmitted using API 120 back to the web server 104.

Data store 130 is depicted as singular element but may in actuality be multiple data stores. The specific storage layout and model used in by data store 130 may take a number of forms indeed, a data store 130 may utilize multiple models, Data store 130 may be, but is not limited to, a relational database (e.g., SQL), non-relational database (NoSQL) a flat file database, object model, document details model, graph database, shared ledger (e.g., blockchain), or a file system hierarchy. Data store 130 may store data on one or more storage devices (e.g., a hard disk, random access memory (RAM), etc.). The storage devices may be in standalone arrays, part of one or more servers, and may be located in one or more geographic areas.

User profiles 128 may store the profiles of users that interact with server device 102. A user profile may include a user identifier (e.g., a username) and a password. A user profile may also include a user's name, address, phone number, account numbers, unique identifiers, and other information.

In various embodiments, the sensor monitoring component 112 can assist with determining location and proximity of one or more users or persons or groups of users, by communicating with a sensor or sensors carried with the users or located at a specific geographic location (e.g., business premises) corresponding to a retail establishment, or other entity. The location determining component 114 can use received signals from the sensor monitoring component 112 and/or geolocation data from user devices to determine whether a first group of a plurality of users is located within a first portion of a premises, and determining whether a second group the plurality of users is located within a second portion of the premises. As defined herein, a group may include one or more persons or users. According to various embodiments, the notification component 116 can send an alert to a user device if the user or group of users are not within their portion of the premises. The rewards component 126 can determine whether the specific geographic location is affiliated with an entity that offers and/or supplies) rewards to users for maintaining social distancing, and/or provide rewards to the first group and the second group when the first group is located within the first portion and the second group is located within the second portion for a predetermined duration of time (e.g., a programmable and/or adjustable duration of time) at the premises. The present subject matter may further provide internal tools, such as a look-up tool or premises owner interface 124, which may enable premises owner employees to review and update available rewards offers and statuses.

For instance, an application may be provided by the server 102 that permits a retail user (e.g., via the client device 106) to offer and update available rewards. That is, the application may provide one or more user interfaces that permit a retail user to define a rewards offer, and the conditions associated with that rewards offer. Satisfaction of the conditions may result in the reward being delivered. For example, the conditions associated with a rewards offer may be associated with a customer (or potential customer) or group of customers maintaining social distancing when a location of that customer or group of customers corresponds to a geographic location of a retail establishment of the retail user.

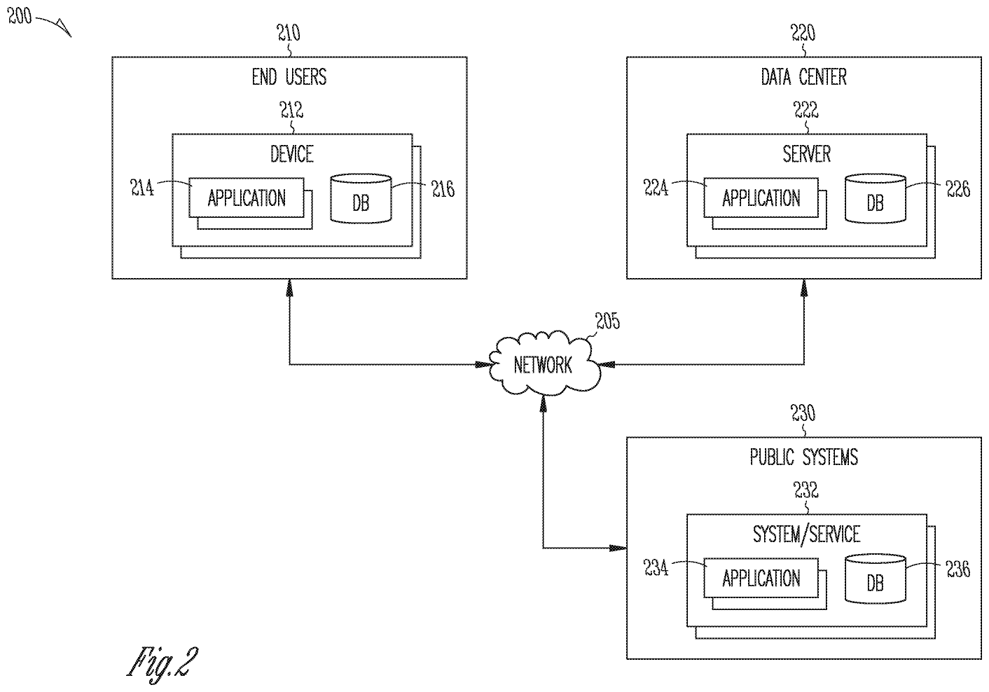

FIG. 2 illustrates an exemplary infrastructure for providing the system of the present subject matter. The infrastructure may comprise a distributed system 200 that may include a client-server architecture or cloud computing system. Distributed system 200 may have one or more end users 210. An end user 210 may have various computing devices 212, which may be a machine 500 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The business entity may be a computer service provider, as may be the case for a cloud services provider, or it may be a consumer product or service provider, such as a retailer. The data center 220 may comprise one or more applications 224 and databases 226 that are designed to interface with the applications 214 and databases 216 of end-user devices 212. Data centers 220 may represent facilities in different geographic locations where the servers 222 may be located, Each of the servers 222 may be in the form of a machine(s) 500.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 500.

The end-user devices 212, data center servers 222, and public systems or services 232 may be configured to connect with each other via the network 205, and access to the network by machines may be made via a common connection point or different connection points, e.g. a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

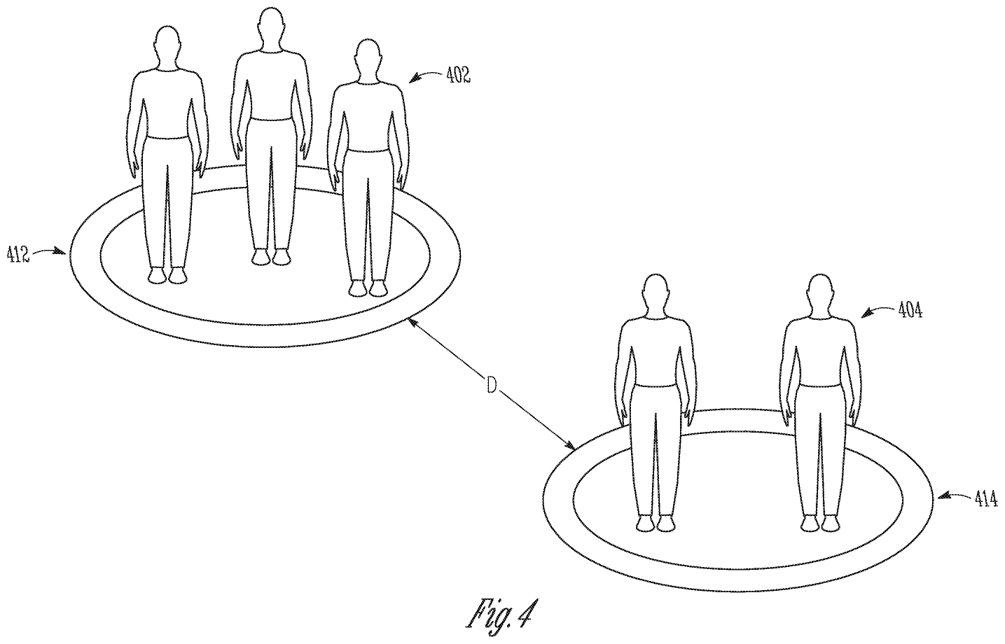

The present subject matter provides incentives for a person, or group of people, to avoid coming too close to another person, or group of people. In some embodiments (such as shown in FIG. 4), the present subject matter provides incentive to maintain social distancing in a group setting, such as in a check-out aisle at a retail store. Some retail stores have markings or indications on the floor to show designated areas for a single person (or small group or cohort) to stand while waiting in line. The present subject matter can detect that everyone in a line is complying and provide rewards if all are complying, such that the group effort is rewarded, in various embodiments. For example, a retail store may have circles or squares on the floor (respective areas) in the checkout area, such that if all people are within their respective areas, the group is complying with social distancing.

In various embodiments, a mat or rug or runner or tile or other type of floor covering is used with embedded sensing capability, in communication with sensor monitoring component 112, to determine compliance. In some embodiments, the floor covering includes pressure sensors to sense weight of a person or persons. In some embodiments, the floor covering includes a material that is less rigid that the floor and that can sense deflection in the floor covering to determine if a person or persons are standing on the floor covering. The floor covering may include a piezoelectric sensor or other type of sensor to sense deflection, in various embodiments. The sensor may detect mechanical stress and send an electrical or electromagnetic pulse in response to the detection to sensor monitoring component 112, in an embodiment. The sensor may detect a predetermined (e.g., a programmable and/or adjustable) weight of a person or persons, in some embodiments.

While in some examples, the sensor or sensors on or in the floor may communicate via discrete signals, in various other examples, a continuous stream of communication may be established between the sensor and the system and/or user device (e.g., the user's smartphone). Accordingly, in some examples, the person may be periodically “checked” to ascertain if the person is maintaining social distancing, or if the person is consistently social distancing over a given period of time. The period of time (e.g., frequency of polling) may be one minute, five minutes, or thirty minutes, to name a few examples. In this manner, the system can determine if the person or group of persons are maintaining social distancing.

The present subject matter provides incentives by providing rewards or gamification of social distancing for a group of people in a commercial premises, such as by using rewards component 126. For example, if all persons in a particular checkout line are complying with social distancing based on the sensed data collected by sensor monitoring component 112 or location determination component 114 discussed above, the floor area may light up, such as around the perimeter of the designated areas using rewards component 126. In another example, a particular music is played by rewards component 126 if all persons are complying. In other examples, flashing lights, disco balls and/or confetti may be included if all persons are complying. Such gamification provides social distancing compliance incentives, in various embodiments. Other types of incentives can be used by rewards component 126 without departing from the scope of the present subject matter. For example, if all persons in a particular checkout line are complying with social distancing, everyone may be awarded a coupon for use at the store or at related stores or both. In another example, if all persons in a particular checkout line are complying with social distancing, everyone may receive a percentage off of their current purchases. This encourages everyone to do their part and coordinate their efforts with other people to obtain the rewards. In some embodiments, the present subject matter provides a punishment for noncompliance, such as a forced donation to charity for all persons if one of the persons does not comply with social distancing using rewards component 126 or notification component 116. In one embodiment, only those persons complying receive rewards, and only a single group needs to comply to obtain rewards. Other numbers of groups can be used without departing from the scope of the present subject matter.

In some examples, the signal to the respective floor portion may be received by the sensor attached to or embedded in the floor and elicit a response from the sensor. For instance, the response may be sent from the sensor if the sensor is within a desired proximity to the phone. In one example, the desired proximity between the respective floor portion and the phone may be the range of communication of the sensor embedded or attached to the floor. Receipt of the response from the sensor of the floor confirms that the floor portion is proximate the smartphone, and the user. As discussed, this may be repeated dynamically or continually over a period of time to ensure that the user is maintaining social distancing. If a response is not received from the sensor of the floor portion, the application can provide a notification to the user that the user has left the floor portion. While described herein as a signal to the sensor from the phone, and a response from the sensor to the smartphone, in various other examples a signal may be sent from the sensor to the smartphone. That is, the sensor may broadcast a beacon, the detection of which (e.g., by the phone) may confirm that the person has maintained social distancing in compliance with local rules, regulations, or retailer requirements.

While described in some examples as including a single sensor, in various other embodiments the portion of the floor may include a plurality of sensors. Each sensor of the plurality may be the same type of sensor, or a different type of sensor. For example, the floor portion may include a first sensor of a first type (e.g., a pressure sensor), and a second sensor of second type (e.g., a weight sensor). A combination of different sensor types offers the benefit of improved data reporting as it offers a more comprehensive report of collected information. While in one example, the first sensor may be used to help determine if the first group of users in maintaining social distancing, and the second sensor may be used to help determine if the second group of users is maintaining social distancing, in various other examples some or all of the plurality of sensors may be used for both purposes.

As previously discussed herein, in various examples the sensor or sensors attached or embedded in the floor portion may be continuously or dynamically polled to determine if the person is maintaining social distancing over an extended period of time. In certain other examples, the sensor or sensors may continuously or periodically transmit a signal (e.g., a beacon) when the sensor or sensors are sensing information, e.g., a pressure level, a weight level, etc. Such a beacon may be located and received by the person's smart phone, for instance. A continuous or dynamic communication stream with the sensors ensures that the person (or group of persons) is consistently social distancing.

The rewards can be multiplied for each person in a compliance zone, in some embodiments. For example, if five people (or groups of people) are in line and all five maintain social distancing, all five get rewards and the rewards can be multiplied by five using rewards component 126. Flashing lights can be used as a reward, in an embodiment. The present subject matter provides incentives for group participation in social distancing. For example, because of social distancing, checkout lines can appear longer, and long lines can dissuade persons from shopping at the store. However, the present subject matter provides rewards and enjoyment and makes checkout lines more entertaining and makes the time go by faster by encouraging group cooperation to make the experience more enjoyable and tolerable, and ultimately safer.

The application can provide other positive or negative incentives for social distancing compliance, in various embodiments. For example, a notification can be provided on a user device by notification component 116 if not in compliance. Likewise, a social media post to user-selected accountability partners (similar to a dieting regime) can be made by notification component 116 to let others know if the user is in compliance. This can provide peer pressure as an incentive to the user to comply with the desired behavior.

A participating retailer may provide bonus cash back for compliance by a user or group of users in the participating retailer's store or premises, in an embodiment. For example, a user may get a discount at the retailer location for compliance using rewards component 126. A participating financial institution may provide a mechanism to round-up purchases and put the difference in a savings account as a reward to the user for compliance, in an embodiment. For example, if the purchase is for $1.60, an additional $0.40 could be transferred from the user's checking to savings as a reward. A similar transfer could be used as a negative incentive to another user, as funds transferred to a savings account are more difficult to access, in an embodiment. In another embodiment, as a negative incentive, the user may be forced to make a fixed donation to a charity, such as the Humane Society, for every time they violate social distancing requirements. The aforementioned donation could be an escalating amount for repeat offenders, in an embodiment.

The rewards component 126 of the present application provides a rewards points system, in various embodiments. The user can get points (similar to airline or credit card points) for compliance, and can redeem the points to purchase goods or services at participating merchants, in various embodiments. A user may receive a number of points scaled to the percentage of compliance of social distancing, in various embodiments. In various examples, compliance with one or more rules, regulations, policies, or retailer requirements for maintaining social distancing may be detected and enforced using the techniques discussed herein. Satisfaction of one or more conditions associated with a reward may be determined based on the techniques described herein. If the conditions are satisfied, the reward may be granted.

In some embodiments, a smartphone or wearable device of a user will detect the smartphone or wearable device (or other Bluetooth activated device) of another person in close proximity, to determine if the distance between the user device and the device of the other person is less than an adjustable threshold using sensor monitoring component 112. In various embodiments, a smartphone can use a personal hotspot Wi-Fi to determine proximity of another person's device. In some embodiments, proximity can be limited to six feet. In other embodiments, a proximity limit between a device of a first person and a device of a second person can be set to 8 feet, to account for where on the other person the device is located, to keep people six feet apart.

In some embodiments, the premises owner (such as a retailer or financial institution) can use its own network, such as an existing Wi-Fi network having beacons or repeaters, to locate individuals for purposes of the present subject matter using location determining component 114. In some embodiments, the premises owner may have a surveillance system with cameras that is used to locate individuals for purposes of the present subject matter. The surveillance system may be capable of tagging a person to identify them as they enter the premises, such as by using a motion sensor, camera (if within line of sight) or infrared sensor (triggered by body heat threshold) to detect the person.

In some embodiments, a premises owner such as a retailer may use their retail software application to enable tracking of customers to enforce social distancing, as a type of location determining component 114. The retailer may provide an “opt-in” on the application to allow the application to track the user while on the retail premises, in an embodiment. The application can then use the geotracking of the customer/user device to provide social distancing tracking. In one embodiment, security tags (such as those used on expensive items in a retail store to prevent shoplifting) can be used to track individuals. A membership card of a user for a retailer (such as a rewards card) can have a unique identifier, include an RFID chip, or be made of a material similar to a security tag to enable tracking within the store, in some embodiments. The social distancing application of the present subject matter can be a cloud-based system managed by the retailer, or by a third party, in various embodiments. If a person does not have the store membership card, they can still be monitored with respect to other individuals for proximity and social distancing, but will not receive the rewards or alerts for participation and compliance.

In some embodiments, each retail location can customize the distance rules, such as by using premises owner interface 124. For example, in some stores people in adjacent aisles may be closer than six feet apart, but deemed not in violation of social distancing because of large dividers or high shelves between the aisles. In various embodiments, the application of the present subject matter knows details of the store layout, or uses available video to determine store features that mitigate distancing.

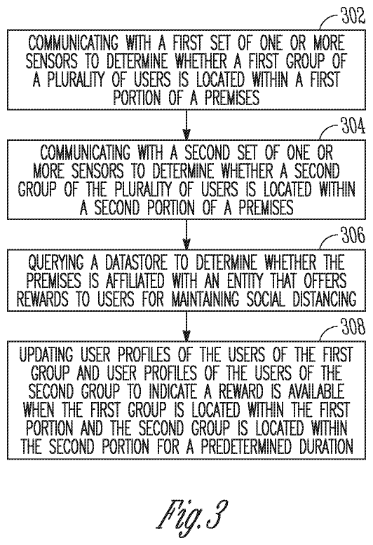

FIG. 3 illustrates an example embodiment of a method for sensor-based social distancing, according to various embodiments. The method includes communicating with a first set of one or more sensors to determine whether a first group of a plurality of users is located within a first portion of a premises at step 302, and communicating with a second set of one or more sensors to determine whether a second group of the plurality of users is located within a second portion of the premises at step 304. The method further includes querying a datastore to determine whether the premises is affiliated with an entity that offers rewards to users for maintaining social distancing at step 306, User profiles of the users corresponding to the first group and user profiles of the users corresponding to the second group are updated to indicate a reward is available when the first group is located within the first portion and the second group is located within the second portion for a predetermined duration (e.g., programmable and/or adjustable duration) at the premises, at step 308. The method of FIG. 3 may be performed using the system components described in FIG. 1, in various embodiments.

Various examples are directed to computer-implemented systems and methods for gamification of social distancing. A method includes determining whether a first group of a plurality of users is located within a first portion of a premises, and determining whether a second group the plurality of users is located within a second portion of the premises. As discussed herein, the “first portion” and “second portion” and “nth portion” of the premises may be defined in a number of ways. For example, sensors on the floor or within the floor may indicate the respective portion, or a perimeter of the respective portion. The respective portion may be indicated by markings on the floor to provide users with a guide for social distancing, for example. Other location determination can be used to define the respective portion, such as communication with sensors, beacons, routers or personal devices of users. If the premises is affiliated with an entity that offers rewards to users for maintaining social distancing, rewards are provided to the first group and the second group when the first group is located within the first portion and the second group is located within the second portion for a predetermined duration at the premises. While described in some examples in the context of a first group and a second group of a plurality of users, in various other examples the described techniques may be used with more than two groups of people.

FIG. 4 illustrates example embodiments of sensors for use at a premises, according to various embodiments described herein. In some embodiments, the present subject matter provides an incentive to maintain social distancing in a group setting, such as in a check-out aisle at a retail store. Some retail stores have markings or indications on the floor to show designated areas for a single person (or small group or cohort) to stand while waiting in line. The present subject matter can detect that everyone in a line is complying with markings or indications on the floor and provide rewards if all are complying, such that the group effort is rewarded, in various embodiments. For example, a retail store may have circles 412, 414 on the floor (respective areas) in the checkout area, such that if a first group 402 is within a first respective area or portion 412 and a second group 404 is within a second respective area or portion 414, the groups are complying with social distancing. It will be understood that a group may include one or more persons, and that a plurality of groups (with a plurality of respective areas) may participate without departing from the scope of the present subject matter. In various embodiments, the respective areas are spaced a distance D from the other respective areas to ensure social distancing.

According to various embodiments, at least one of determining whether the first group is located within the first portion of the premises or determining whether the second group is located within the second portion of the premises includes using sensors within a floor of the premises. In such an example, the first portion of the premises may correspond to a first area in the floor space of a building, and the second portion of the premises may correspond to a second area in the floor space of the building. For instance, the first portion and second portion may be indicated by markings on the floor of the premises. The sensors are included within a floor tile or carpeting, in various embodiments. In some embodiments, the method further includes determining whether a third group the plurality of users is located within a third portion of the premises, and providing rewards to the first group, the second group, and the third group when the first group is located within the first portion, the second group is located within the second portion, and the third group is located within the third portion for a predetermined duration. It will be understood that additional groups can be included without departing from the scope of the present subject matter.

According to various embodiments, at least one of determining whether the first group is located within the first portion of the premises or determining whether the second group is located within the second portion of the premises includes using sensors on a floor of the premises. The sensors can be included within a floor mat, a rug, or other floor covering, in various embodiments. The sensors can include one or more of pressure sensors, weight sensors, mechanical stress sensors, or piezoelectric sensors, in various embodiments.

For example, the sensor is polled by the system for sensor data (e.g., pressure data, weight data, mechanical strain, etc.), and the sensor provides the sensor data. The system compares the sensor data to predetermined thresholds to make a determination that a person or persons is present in the portion (e.g., compare weight data to weight of a person or persons). In some embodiments, providing rewards to the first group and the second group includes one or more of providing points, providing cash back from a purchase, providing a discount on a purchase to the first group and the second group. In various embodiments, providing rewards to the first group and the second group includes one or more of turning on lights or audible sounds at or near the first portion and the second portion. According to various embodiments, the first portion of the premises and the second portion of the premises are indicated by markings on the floor. Determining whether the premises is affiliated with an entity that offers rewards to users includes using a look-up table of participating entities, in various embodiments.

Various embodiments include a system including a computing system comprising one or more processors and a data storage system in communication with the one or more processors, where the data storage system comprises instructions thereon that, when executed by the one or more processors, causes the one or more processors to execute methods of the present subject matter. Various embodiments include a non-transitory computer-readable storage medium, the non-transitory computer-readable storage medium including instructions that, when executed by computers, cause the computers to perform operations to execute methods of the present subject matter.

Various embodiments of the present subject matter generally relate to assisting with maintaining social distancing among users. An establishment may have areas associated with where users generally stand in line, such as at a check out aisle in a retail establishment, which are spaced apart. The areas, which may be squares or some other shape, are consecutively lined up and are spaced apart from each other such that when users stand in each of the areas, the users are socially distanced from each other. In other words, when users stand within the areas, they are ensured to be six feet (or other designated distance) apart from each other. When the user is waiting in line and is standing in the area, indicia may be presented, such as the area lighting up, that indicates the user (or group of users) is standing in the proper area and is socially distancing.

In one embodiment, the present system determines whether there are users within a location, activates areas (or portions) on which users should stand when social distancing is required; and activates indicia when a user is standing on the area that allows for social distancing. The areas may be solar powered, such as when lines are to be maintained outdoors, the areas may receive power by plugging into an electrical outlet, or the areas may be powered via a piezoelectric effect. In order to detect when the user is on the area, the area may have near field communications (NFC) and communicate via NFC with the user's device to determine that the user is on the area in order to provide indicia that the user is properly socially distancing. Furthermore; the area may include other types of sensors, such as weight sensors, proximity sensors, or work in conjunction with a surveillance system of the establishment to determine when a user is on the area. Also, if a determination is made that no one else is in the retail establishment or waiting in line, the areas may be powered down since social distancing will not be required.

Various embodiments include consecutively lined up areas (or portions) which are configured to provide indicia when a user is in the area where being in the area maintains social distancing and how the areas are powered. In some embodiments, when the user stays on the area, the user is provided with rewards as discussed above. Various locations determining means can be used, such as NFC, surveillance video, and sensors as mentioned above.

Moreover, when users are socially distancing, awards may be provided to the users. For example, a user may get cash back on their credit card or rewards, i.e., store cash, that are redeemable at the retail establishment. In various embodiments, the provided rewards may include points (cash-back, discount, other standard points options) from participating sponsoring organizations (e.g., retailer who's store you're in, local or national government, etc.) who can determine framework for points allocation based on how strong they want the social distancing incentive. According to various embodiments, the present subject matter may identify who the sponsoring organization is based on geolocation, QR-code scan at entrance to location, or hand-entry of an identifier associated with a location. Other provided rewards may include a sweepstakes entry or a charitable donation, in various embodiments. In addition, the rewards may be multiplied when all people are standing in their areas and social distancing. For example, when two groups in the same checkout line are social distancing as determined by the present subject matter, rewards can be doubled, and when three groups are social distancing, rewards can be tripled. Other multiples can be used without departing from the scope of the present subject matter.

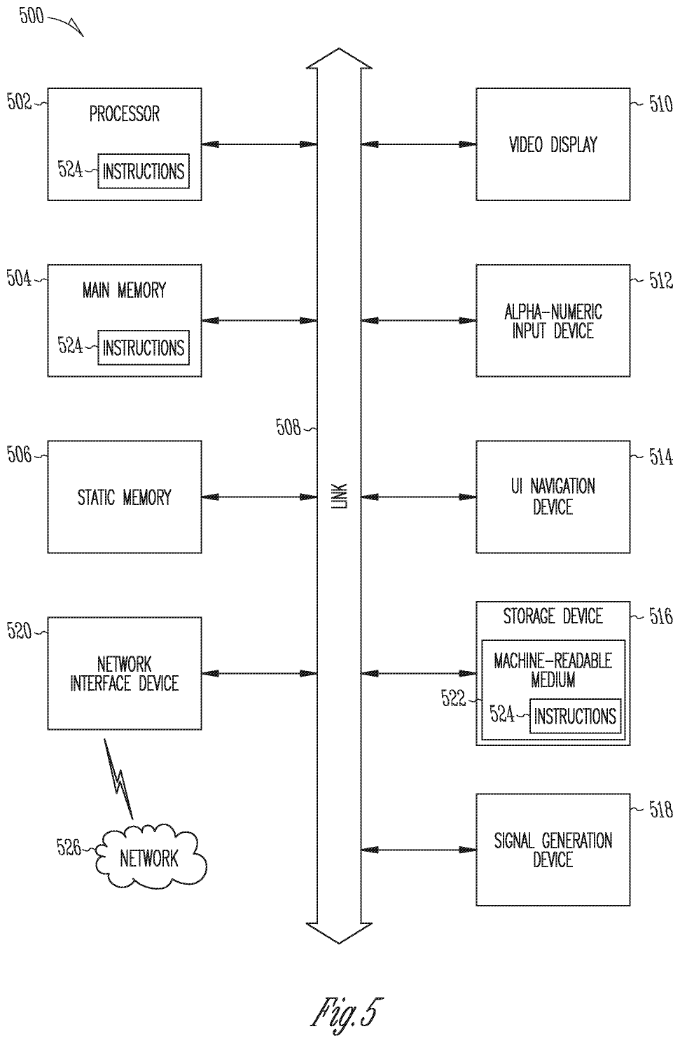

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a set-top box (STB), a personal digital assistant (PDA), a mobile or cellular telephone such as a smartphone, a wearable device such as a smart watch, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The data storage device 516 includes a machine-readable medium 522 on which is stored one or more sets of data structures and instructions 524 (e.g., software) embodying or utilized by any one or more of the methodologies or functions described herein. The instructions 524 may include a machine learning system or algorithm, and may also reside, completely or at least partially, within the main memory 504, static memory 506, and/or within the processor 502 during execution thereof by the computer system 500, with the main memory 504, static memory 506, and the processor 502 also constituting machine-readable media.

While the non-transitory computer-readable storage medium 522 is illustrated in an example embodiment to be a single medium, the term “machine-readable medium” or “computer-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions (e.g., instructions 524) for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone system (POTS) networks, and wireless data networks (e.g., Wi-Fi, 3G, and 6LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
communicating, by a computer system, with a first set of one or more sensors to determine whether a first group of a plurality of users is located within a first portion of a premises;
communicating, by the computer system, with a second set of one or more sensors to determine whether a second group of the plurality of users is located within a second portion of the premises;
determining, by the computer system, whether the premises is affiliated with an entity that offers rewards to users for maintaining social distancing, including using a geographic location of the premises as an input to query a datastore; and
updating, by the computer system, user profiles of the users of the first group to indicate a first reward is available and user profiles of the users of the second group to indicate a second reward is available when the first group is located within the first portion and the second group is located within the second portion for a predetermined duration at the premises that is affiliated with the entity that offers rewards to users for maintaining social distancing, wherein the first reward is calculated by multiplying by a first number of users in the first group and the second reward is calculated by multiplying by a second number of users in the second group.

2. The computer-implemented method of claim 1, wherein at least one of the first set of one or more sensors and the second set of one or more sensors includes a sensor within a floor of the premises.

3. The computer-implemented method of claim 2, wherein the sensor is within a floor tile or carpeting of the premises.

4. The computer-implemented method of claim 1, further comprising:
communicating, by the computer system, with a third set of one or more sensors to determine whether a third group the plurality of users is located within a third portion of the premises; and
providing, by the computer system, rewards to the first group, the second group, and the third group when the first group is located within the first portion, the second group is located within the second portion, and the third group is located within the third portion for the predetermined duration.

5. The computer-implemented method of claim 1, wherein at least one of the first set of one or more sensors and the second set of one or more sensors includes a sensor on a floor of the premises.

6. The computer-implemented method of claim 5, wherein the sensor is included within a floor mat.

7. The computer-implemented method of claim 5, wherein the sensor is included within a rug.

8. The computer-implemented method of claim 5, wherein the sensor includes a pressure sensor.

9. The computer-implemented method of claim 5, wherein the sensor includes a weight sensor.

10. The computer-implemented method of claim 5, wherein the sensor includes a mechanical stress sensor.

11. The computer-implemented method of claim 5, wherein the sensor includes a piezoelectric sensor.

12. A system comprising:
a computing system comprising one or more processors and a data storage system in communication with the one or more processors, wherein the data storage system comprises instructions thereon that, when executed by the one or more processors, causes the one or more processors to:
communicate with a first set of one or more sensors to determine whether a first group of a plurality of users is located within a first portion of a premises;
communicate with a second set of one or more sensors to determine whether a second group of the plurality of users is located within a second portion of the premises;
determine whether the premises is affiliated with an entity that offers rewards to users for maintaining social distancing, including using a geographic location of the premises as an input to query a datastore; and
provide a first reward to the first group and a second reward to the second group when the first group is located within the first portion and the second group is located within the second portion for a predetermined duration at the premises that is affiliated with the entity that offers rewards to users for maintaining social distancing, wherein the first reward is calculated by multiplying by a first number of users in the first group and the second reward is calculated by multiplying by a second number of users in the second group.

13. The system of claim 12, wherein the reward includes points added to user profiles of the users of the first group and user profiles of the users of the second group.

14. The system of claim 12, wherein the reward includes cash back from a purchase to users of the first group and users of the second group.

15. The system of claim 12, wherein the reward includes a discount on a purchase to users of the first group and users of the second group.

16. The system of claim 12, wherein the reward includes turning on lights at or near the first portion and the second portion.

17. The system of claim 12, wherein the reward includes turning on audible sounds at or near the first portion and the second portion.

18. A non-transitory computer-readable storage medium, the non-transitory computer-readable storage medium including instructions that; when executed by computers, cause the computers to perform operations of:
communicating with a first set of one or more sensors to determine whether a first group of a plurality of users is located within a first portion of a premises;
communicating with a second set of one or more sensors to determine whether a second group of the plurality of users is located within a second portion of the premises;
querying a datastore to determine whether the premises is affiliated with an entity that offers rewards to users for maintaining social distancing;
determining whether the premises is affiliated with an entity that offers rewards to users for maintaining social distancing, including using a geographic location of the premises as an input to query a datastore; and
updating user profiles of the users of the first group to indicate a first reward is available and user profiles of the users of the second group to indicate a second reward is available when the first group is located within the first portion and the second group is located within the second portion for a predetermined duration at the premises that is affiliated with the entity that offers rewards to users for maintaining social distancing, wherein the first reward is calculated by multiplying by a first number of users in the first group and the second reward is calculated by multiplying by a second number of users in the second group.

19. The non-transitory computer-readable storage medium of claim 18, wherein the first portion of the premises and the second portion of the premises are indicated by markings on a floor of the premises.

20. The non-transitory computer-readable storage medium of claim 18, wherein querying a datastore to determine whether the location is affiliated with an entity that offers rewards to users includes using a look-up table of participating entities.
